(19) United States
(12) Patent Application Publication
(10) Pub. No.: US 2022/0005620 A1
(43) Pub. Date: Jan. 6, 2022

(54) ULTRASONIC MONITORING SYSTEM OF THE NUCLEAR REACTOR ABOVE CORE SPACE

(71) Applicant: STATE ATOMIC ENERGY CORPORATION “ROSATOM” ON BEHALF OF THE RUSSIAN FEDERATION, Moscow (RU)

(72) Inventors: Yuriy Petrovich GREBENKIN, Dimitrovgrad, Ulyanovsk region (RU); Sergey Ivanovich ZHULINSKIY, Dimitrovgrad, Ulyanovsk region (RU); Vitaliy Aleksandrovich NEVEROV, Dimitrovgrad, Ulyanovsk region (RU); Viktor Mikhailovich SOKOLOV, Dimitrovgrad, Ulyanovsk region (RU)

(21) Appl. No.: 17/297,403

(22) PCT Filed: Dec. 29, 2018
(86) PCT No.: PCT/RU2018/000913

§ 371 Date: May 26, 2021

(30) Foreign Application Priority Data
Nov. 26, 2018 (RU) 2018141726

(51) Int. Cl. G21C 17/007; G01N 29/04

(52) U.S. Cl. CPC G21C 17/007; G01N 29/04

(57) ABSTRACT

System for detecting, in a space being monitored, for example a gap, obstacles to rotation of the rotating plugs during refueling operations. The system includes an ultrasound reflector configured in the form of a ring on which at least one row of vertical cylindrical rods is arranged. The ring is attached to one of the thermal screens surrounding the reactor core, preferably one proximate to the nuclear reactor vessel. The spacing at which the cylindrical rods are arranged in the row is less than the spacing between the assemblies.

The invention relates to nuclear technology and can be used to monitor the state of the liquid metal cooled nuclear reactor above core space. The principle of the ultrasonic monitoring system operation is based on the excitation and response reception of ultrasonic signals reflected from structural elements located in the space (controlled clearance) between the upper level of the heads of fuel assemblies and the lower level of the rotating plugs of the opaque liquid metal (for example, liquid sodium) cooled reactor. This system is used to detect in a controlled space (controlled clearance) obstacles to the rotation of rotating plugs during reloading operations.

Systems in which the scanning ultrasonic beam propagates in the horizontal direction are referred to as horizontal acoustic imaging systems. They are designed to obtain analogs of the optical image of objects located or found in the above core space of the opaque liquid metal cooled reactors. Monitoring of optically opaque above core spaces in reactors can be performed by using ultrasonic waves propagating in liquid metal coolants. In this capacity, ultrasonic signals are applicable in reactors with coolants that are opaque to light (sodium, lead, etc.); and the signals can provide analogs of an optical image of objects with good resolution.

To increase the reliability of detection of structural elements, a special ultrasound reflector is installed in the nuclear reactor, and by decreasing the signal from it, it can be judged if there is an object falling into the zone of the ultrasonic beam.

As a rule, the monitoring systems of the reactor above core space are developed taking into account the design of a particular reactor and cannot be transferred to another reactor without certain changes associated with adaptation to the design features of the above core space of each specific apparatus.

There is a system of horizontal acoustic imaging for determining the clearance between the lower part of the control rods and the heads of the fuel assemblies (application No 58-34799, Japan). The device contains an ultrasonic transducer placed on a bar and connected to an ultrasonic generator and, through an amplifier, with a signal processing and identification device, an ultrasound reflector. In this device, the bar with the ultrasonic transducer is rotated at a constant angular velocity and is moved in height after each revolution. During one revolution, ultrasonic pulses are successively emitted, and reflected pulses are received in the intervals between them.

The disadvantages of this technical solution is that it is not always possible to determine the presence or absence of an object in the above core space, when the beams reflected from the object do not fall into the transducer's plane.

There is a system for ultrasonic monitoring of the position of structural elements in the above core space of a liquid metal cooled nuclear reactor (U.S. Pat. No. 4,290,849), including an ultrasonic transducer for emitting and receiving a pulsed ultrasonic signal, means for turning the sensor at a given angle, main and additional reflectors having several planes oriented in the scanning direction, means for supplying power to the transducer and means for displaying ultrasonic signals. The incident ultrasonic wave successively reflects from the additional ultrasound reflector, the main reflector and the object (if any) located in the clearance between the control rod components and the fuel assembly heads, and then returns to the ultrasonic transducer along the path already traveled. To eliminate the interference of signals of the incident and reflected ultrasonic waves, the reflector planes are placed at different distances from the transducer.

In the known technical solution, two segments of straight lines corresponding to the path of the ultrasonic beam from the ultrasound source to the ultrasound reflector and from the ultrasound reflector to the ultrasound receiver are indicated as the location of the detected obstacle, and the answer is not given on which of the segments the obstacle is located.

The task of this technical solution is to improve the reliability of obstacles detection in the controlled above core space and to determine their location.

To solve this problem, the system of ultrasonic monitoring of the above core space of the liquid-metal cooled nuclear reactor, including the ultrasound reflector and the scanning ultrasonic mechanism with drives, containing a bearing rod with sealed ultrasonic transducers, the acoustic axis of which coincides with one of the horizontal planes crossing the space filled with a liquid-metal coolant (controlled clearance between the lower elevations of the disengaged control rod components and the upper elevations of the fuel assembly heads), has the ultrasound reflector in the form of a ring, on which there is at least one row of vertical cylindrical rods, the ring is attached to one of the thermal shields surrounding the core, mainly closest to the nuclear reactor vessel, and the pitch with which the cylindrical rods are located in a row is less than the pitch between the assemblies (the pitch of the reactor lattice).

Placing the ultrasound reflector (rings with cylindrical rods) on the thermal shield located at the closest distance from the reactor vessel provides monitoring of the position of standard structures and detection of obstacles to the rotation of rotating plugs in the entire controlled volume of the above core space.

Cylindrical rods are located in rows at equal distances from the center of this ring and evenly around its circumference (for the convenience of automatic control over the level of the reflected signal when scanning using the ultrasound reflector ultrasonic beam from the central cell):

The height of the cylindrical rods is such that they cover the entire clearance between the upper level of the fuel assembly heads and the lower level of the reactor rotating plugs and the lower elevations of the disengaged control rod components, and provide the possibility of performing layer-by-layer scanning in the entire controlled space.

One of the cylindrical rods is located at a selected (smaller or larger in relation to the rest of the rods) distance from the center of this ring and is uniquely determined during ultrasonic scanning by the time of echo pulse receipt. It is convenient to take the direction of the axis of the ultrasonic transducer towards this rod as the origin of the rotation angle of the ultrasonic transducer and use it to more accurately calculate the angles of its rotation during scanning.

The pitch with which the cylindrical rods are located on the ring in a row is less than the pitch between assemblies. Otherwise (with a larger pitch) those floating assemblies will not be detected, which, when scanning using the ultrasound reflector ultrasonic beam, will appear in the gap between the cylindrical rods.

In cases where the floating assembly does not cover the entire controlled clearance, but entered it only with its upper narrow part (head) to the height of one ultrasonic scanning layer, the shadow from the head may fall into the gap between the cylindrical rods, and the floating will not be detected by the system. To exclude such cases, the cylindrical rods of the next row are located in the gap between the cylindrical rods of the previous row.

To ensure the possibility of unambiguous determination of the origin of the rotation angle of the ultrasonic transducer and a more accurate calculation of angles of its rotation during scanning, one of the cylindrical rods is located at a selected (smaller or larger in relation to the rest of the rods) distance from the center of this ring.

The cylindrical rods are fixed on the ring in such a way that they are located on the extensions of the lines passing through the center of the core and the centers of the heads of the distant fuel assemblies.

The lateral surface of the cylindrical rods is rough, for example, in the form of a cruciform knurling, which increases the reflectivity of the cylindrical rods and ensures the return of the ultrasonic signal to the ultrasonic transducer regardless of its location (in the center or at the periphery of the controlled space) during the monitoring process.

During long-term operation of the reactor, the geometric dimensions and shape of its elements change, including an increase in the vertical deviation of the generatrix of the cylindrical surface of the rods, which leads to a significant decrease in the amplitude of the echo signal and, as a consequence, to a decrease in the probability of detecting floating distant assemblies.

The presence of roughness increases the likelihood of detecting floating distant assemblies.

When using the ultrasonic monitoring system of the above core space in a “large” reactor, it is advisable to form a corner reflector on the lateral surface of the cylindrical rods, which shall have the ability to return the incident ultrasonic beam in the opposite direction, regardless of the presence of a small angle between the acoustic axis of the corner reflector and the axis of the scanning ultrasonic beam. When forming the ultrasound reflector, it is necessary to place vertical cylindrical rods on the ring so that the axis of the corner reflector is directed to the center of the ring.

As a corner reflector on the lateral surface of the cylindrical rods, at least one conical recess with a right angle at the apex is made, ending with a through hole, the axis of which coincides with the axis of the conical recess and the direction of the axis of the ultrasonic transducer and makes a right angle with the axis of the cylindrical rods.

Cylindrical rods can be arranged in the form of two (or more) annular rows, offset relative to each other so that the rods of the outer row are relative to the direction to the center of the ring between adjacent rods of the inner row.

A scanning ultrasonic mechanism with drives, including a supporting bar with sealed ultrasonic transducers (emitter and receiver of ultrasonic signals)

b

is installed in the space under the fuel assembly overload channel located on the periphery of the small rotating plug of the reactor, or in the space freed up after removing the embedded pipe from the reactor, which is intended to be placed in the center of the core of a loop channel or other irradiation device.

Cylindrical rods are installed on a ring with a certain pitch, so that, when scanning them one by one, the ultrasonic signals reflected from adjacent rods and reaching the ultrasonic transducer overlap in space at least at a level of 0.707 in order to exclude the loss of an informative signal about the presence of an obstacle in space between directions to adjacent rods, for example, about the presence of a floating assembly.

The pitch between the cylindrical rods is associated with the pitch between the assemblies and the diameter of the ultrasonic beam at a level of 0.707, depending on the transducer device, the ultrasound frequency used, the velocity of its propagation in the medium, and the distance to the irradiated object, i.e. to the adjacent rods, namely, the pitch between the cylindrical rods is set less than the pitch between the assemblies and is chosen so that the ultrasonic beams reflected from the adjacent rods overlap on the receiving surface of the ultrasonic transducer.

This ensures the presence of an informative signal (a decrease in the signal from the ultrasound reflector) in the presence of an obstacle in the path of the ultrasonic beam, regardless of how far from the ultrasonic transducer the obstacle appears and what is the slope of its surface.

The system of ultrasonic monitoring of the nuclear reactor above core space is illustrated by the figures.

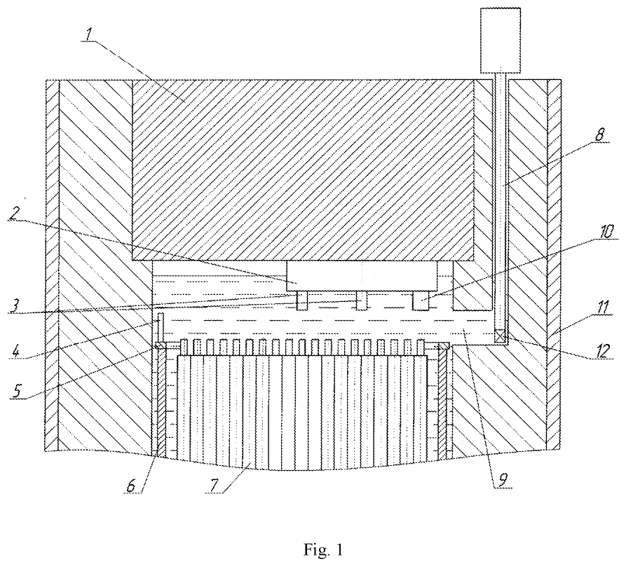

FIG. 1 shows a vertical section of a reactor with elements of the acoustic imaging system located outside the rotating plugs, where:

1 is a large rotating plug; 2 is a small rotating plug with control rod components; 3 are control rod guide pipes; 4 is a cylindrical rod; 5 is a ring; 6 is a thermal shield; 7 is a fuel assembly; 8 is an acoustic imaging probe; 9 is a liquid metal coolant; 10 is a reloading channel; 11 is a reactor vessel; 12 is an ultrasonic transducer

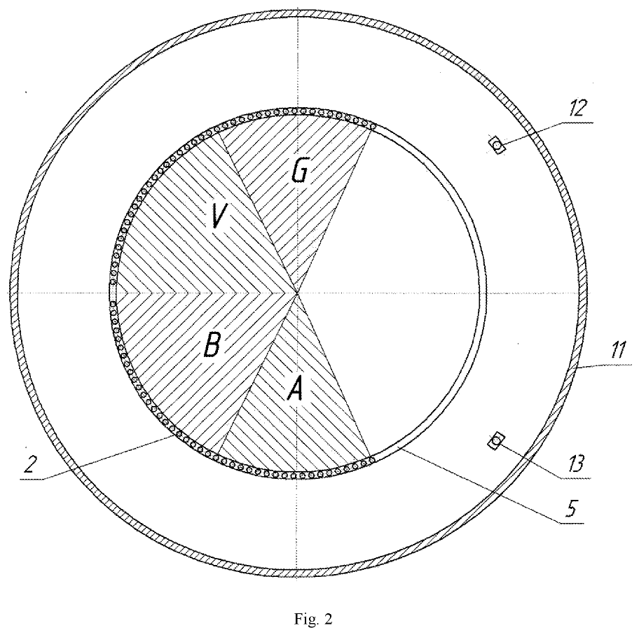

FIG. 2 shows a horizontal section of a reactor with elements of the ultrasonic monitoring system of the nuclear reactor above core space, located outside the rotating plugs, where:

4 are cylindrical rods; 5 is a ring; 11 is a reactor vessel; 12, 13 are ultrasonic transducers. A, B, C, D are sectors of confident detection of obstacles to the rotation of rotating plugs located in the far zone from the corresponding ultrasonic transducer.

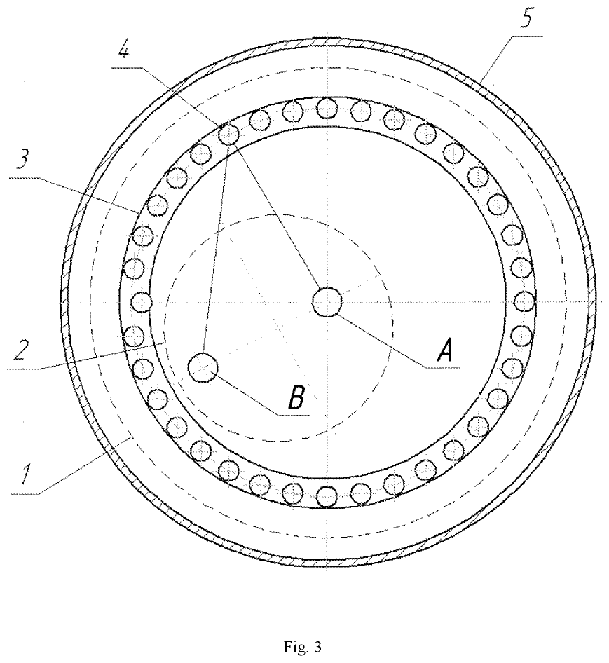

FIG. 3 shows a horizontal section of a nuclear reactor with elements of the ultrasonic monitoring system for the above core space, where:

1 is a large rotating plug (shown conventionally); 2 is a small rotating plug (shown conventionally); 4 are cylindrical rods; 5 is a ring; 11 is a reactor vessel; 14 is a central channel; 15 is a reloading channel; ultrasonic transducers 12 and 13 are installed in channels 14 and 15, respectively.

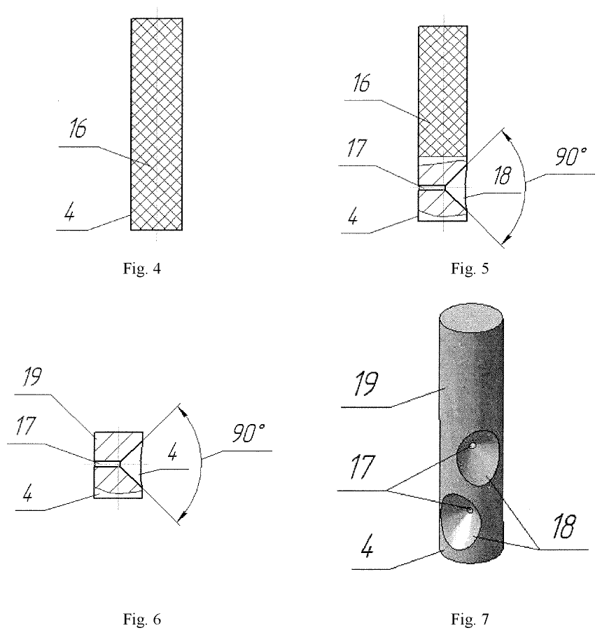

FIGS. 4-7 show different variants of conical recesses on the lateral surface of cylindrical rods, which is especially important for large reactors (core diameter of 4-9 m).

The device works as follows.

Ultrasonic transducers 12 and 13 emit a sequence of ultrasonic signals into the liquid metal coolant 9, extending over the liquid metal coolant 9 along the acoustic axis of each ultrasonic transducer, localized in space in the form of an ultrasonic beam, and during the time intervals between the ultrasonic signals excited in succession, the response ultrasonic signals are received, reflected from structural elements located in the nuclear reactor above core space, namely, in the controlled clearance between the upper level of the fuel assembly heads and the lower level of the rotating plugs (the lower elevations of the devices mounted on the rotating plugs). By the decrease in the amplitude of the echo signals from the cylindrical rods 4 (the so-called bottom signals), the presence of an obstacle shading the ultrasonic beam is judged, and by the presence of the echo signal received in the time interval between the emitted and the bottom signals, it is concluded on the presence of an object with a surface that reflects part of the ultrasonic beam energy in the opposite direction. Layer-by-layer scanning of the above core space with an ultrasonic beam is performed by fixing the ultrasonic transducer 12 at different heights and simultaneously rotating the probe 8.

There are two options for placing the acoustic imaging probe 8 in the reactor:
stationary (in a specially provided place outside the rotating plugs 1 and 2);
removable (an embedded pipe in which during the micro-campaign there was any irradiation device is removed from the central channel of the reactor, and an acoustic imaging probe 8 is installed in its place).

An example of a stationary placement of the acoustic imaging probe 8 in the reactor is shown in FIGS. 1 and 2, an example for a removable version is shown in FIG. 3.

The system of ultrasonic monitoring of the position of structural elements in the nuclear reactor above core space is put into operation on the shutdown reactor before the start of reloading of core assemblies in order to confirm the absence of mechanical connection of the rotating plugs with the core.

With the stationary placement of the acoustic imaging probe 8 in the reactor, the ultrasonic transducer 12 emits a sequence of ultrasonic signals into the liquid metal coolant 9 and receives the reflected signals that came in the opposite direction (an echo signal from one of the cylindrical rods 4 (“bottom” signal) and echo signals from objects caught in the ultrasonic beam path, such as uncoupled control rod components, the head or body of a floating or unsettled fuel assembly, bells for batch control, manipulation tools and foreign objects. The echo signal propagation time and the azimuth of the ultrasonic transducer 12 determine the location of the object that is in the path of the ultrasonic beam. If this object does not create an echo signal extracted from the background noise, then it is detected by a decrease in the amplitude of the “bottom” signal, and only the azimuth of the ultrasonic transducer 12 is used to determine the location. In case of detection of a significant decrease in the amplitude of the “bottom” signal, recorded when scanning the above core space by the ultrasonic transducer 13, the intersection of ultrasonic beams corresponding to the fixed azimuths indicates the most probable location of the object.

To ensure the amplitude of the “bottom” signal, many times higher than the background noise level, the cylindrical rods 4 are oriented by the axes of the conical recesses to the axis of the ultrasonic transducer, and the angle at the apex of the conical recesses is straight to provide a specular reflection of the scanning beam (FIG. 6). The axes of the conical recesses of the cylindrical rods 4, located in sector C, are alternately directed as follows: even ones, to the ultrasonic transducer 12, odd ones, to the ultrasonic transducer 13. The axes of the conical recesses of the cylindrical rods 4, located in sector D, are directed to the ultrasonic transducer 13. The axes of the conical recesses of the cylindrical rods 4, located in sector B, are alternately directed as follows: even ones, to the transducer 13, odd ones, to the transducer 12. The axes of the conical recesses of the cylindrical rods 4, located in sector A, are directed to the transducer 12.

The ultrasound reflector, made in the form of an intermittent row of cylindrical rods, provides a more accurate calculation of the angle of the transducer rotation than the ultrasound reflector, made continuous in the form of a solid cylindrical screen.

To minimize the probability of missing a signal about a foreign object located in the above core space, the pitch between the cylindrical rods shall be commensurate with the pitch of the reactor lattice, and the diameter of the cylindrical rods shall be commensurate with the diameter of the fuel assembly head.

The diameter of the focal spot, in which the main energy of the ultrasonic beam is concentrated, is expediently chosen commensurate with the apparent size of the conical recess. It depends on the size of the ultrasonic transducer, the ultrasound frequency used, the propagation velocity of the ultrasound in the medium, and the distance to the cylindrical rod. The minimum allowable pitch between cylindrical rods simultaneously covered with a focal spot meets Pearson's criterion, according to which the echo signals from these rods are considered distinguishable. If the combination of influencing factors is such that echo signals from adjacent cylindrical rods are difficult to distinguish, then the pitch between adjacent rods is increased, and a second row of such rods is added, located along a concentric circle of larger diameter in the gaps between the rods of the first row.

If the height of the controlled above core space allows, then two or more conical recesses can be made in the cylindrical rods, each of which is oriented towards its own ultrasonic transducer (FIG. 7).

With a removable version of placement of the acoustic imaging probe 8 in the reactor (FIG. 3), the ultrasonic transducers 12 and 13 are installed in the central reloading channels 14 and 15, respectively. FIG. 3 conventionally shows the large rotating plug 1 and the small rotating plug 2. Cylindrical rods 4 can be smooth and have a conical recess oriented to the central channel 14, or with a part of the lateral surface without a conical recess with a right angle at the apex; such surface may be made relief, for example, in the form of a cruciform knurling (FIGS. 5-7). The use of relief shape for the lateral surface of the cylindrical rods allows the use of the mirror-shadow method for the ultrasonic transducer 13 located in the reloading channel 15 or any other channel suitable for installing the probe 8.

What is claimed is:

1. A system of ultrasonic monitoring of the above core space of a liquid metal cooled nuclear reactor, comprising an ultrasound reflector and a scanning ultrasonic mechanism with drives, the scanning ultrasonic mechanism comprising a supporting bar with sealed ultrasonic transducers, the acoustic axis of which coincides with a horizontal plane intersecting the above core space filled with a liquid metal coolant, the above core space being a controlled clearance between the lower elevations of disengaged control rod components and the upper elevations of fuel assembly heads, wherein the ultrasound reflector is made in the form of a ring having at least one row of vertical cylindrical rods, the ring being attached to a thermal shield surrounding the core of the nuclear reactor, and the pitch with which the cylindrical rods are located in a row of the at least one row is less than the pitch between assemblies.

2. The system according to claim 1, the ultrasonic monitoring system is characterized in that cylindrical rods of a subsequent row are located in a gap between cylindrical rods of the previous row to the subsequent row.

3. The system according to claim 1, the ultrasonic monitoring system is characterized in that the cylindrical rods are arranged in rows at equal distances from the center of the ring and evenly around the circumference of the ring.

4. The system according to claim 1, the ultrasonic monitoring system is characterized in that one of the cylindrical rods is located at a selected distance from the center of the ring.

5. The system according to claim 1, the ultrasonic monitoring system is characterized in that a lateral surface of the cylindrical rods is a relief.

6. The system according to claim 1, the ultrasonic monitoring system is characterized in that any lateral surface of the cylindrical rods has at least one conical recess with a right angle at the apex, ending with a through hole, the axis of the through hole (i) coinciding with the axis of the conical recess and the direction of the axis of the ultrasonic transducer and (ii) making a right angle with the axis of the cylindrical rods.

7. The system according to claim 1, the ultrasonic monitoring system is characterized in that the scanning ultrasonic mechanism is installed in different penetrations made in rotating plugs, and on the lateral surface of the cylindrical rods, according to the number of penetrations, conical recesses are made with a right angle at the apex, ending in a through hole, the axis of the through hole coinciding with the axis of the conical recess and the direction to the axis of one of the penetrations, these conical recesses being made along the height of the cylindrical rods, which coincides with the size of the controlled clearance, and wherein the axes of the conical recesses having the same elevation are directed to the axis of the same penetration.

8. The system according to claim 1, the thermal shield (i) being one of a plurality of thermal shields surrounding the core of the nuclear reactor, and (ii) being closest to the nuclear reactor in comparison to every other thermal shield in the plurality of thermal shields.

9. The system according to claim 5, wherein the relief is in the form of a cruciform knurling.
